(19) United States
(12) Patent Application Publication
(10) Pub. No.: US 2005/0053395 A1
(43) Pub. Date: Mar. 10, 2005

(54) Photoreceptor module with retracting backer bars

(75) Inventors: Steven J. Fiore, Hilton, NY (US); Diego Alejandro Pereda, Rochester, NY (US); Michael Nicholas Soures, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/654,783

(22) Filed: Sep. 4, 2003

(51) Int. Cl. G03G 15/00; G03G 15/02

(52) U.S. Cl. 399/116; 399/164; 399/165

(57) ABSTRACT

A photoreceptor module having a plurality of backing members, a tension roller, and a photoreceptor belt, which wraps around the backing members and the tension roller. The tension roller creates tension in the belt. The backing members are retractable such that the tension roller deforms the shape of the belt enough to ease the movement of the module between surrounding modules.

The present invention relates to printing devices and more precisely to a method and apparatus for more easily removing a photoreceptor module therefrom.

The internal components of modern printing devices are generally grouped into various modules. For example, in many devices the photoreceptor, the members that support the belt, and the drivers that keep the belt in motion are part of one module called the photoreceptor module. In addition to the photoreceptor module, the device will typically include other modules other modules such as, for example, a developer module and a fusing module.

When a photoreceptor module is in position within a printing device, the module occupies a particular “footprint” within the device. The footprint of an object is the volume and shape of space it occupies. Like many technologies, there is always a desire for printing devices that operate faster, have more features, and occupy less space. This can lead to the interior of the device becoming crowded. This limits the ability to access interior components of the device.

In more intricate machines, examining or replacing the photoreceptor belt can be challenging to do without risking damage to the photoreceptor. The present method and apparatus allows the user to change the footprint of the photoreceptor module so the module may be removed from a printing device more easily.

Embodiments include a photoreceptor module having a plurality of backing members, a tension roller, and a photoreceptor belt, which wraps around the backing members and the tension roller. The tension roller creates tension in the belt. The backing members are retractable such that the tension roller deforms the shape of the belt enough to ease the movement of the module between surrounding modules.

Embodiments also include a method for detensioning a photoreceptor belt comprising simultaneously retracting multiple backing members.

Various exemplary embodiments will be described in detail, with reference to the following figures, wherein:

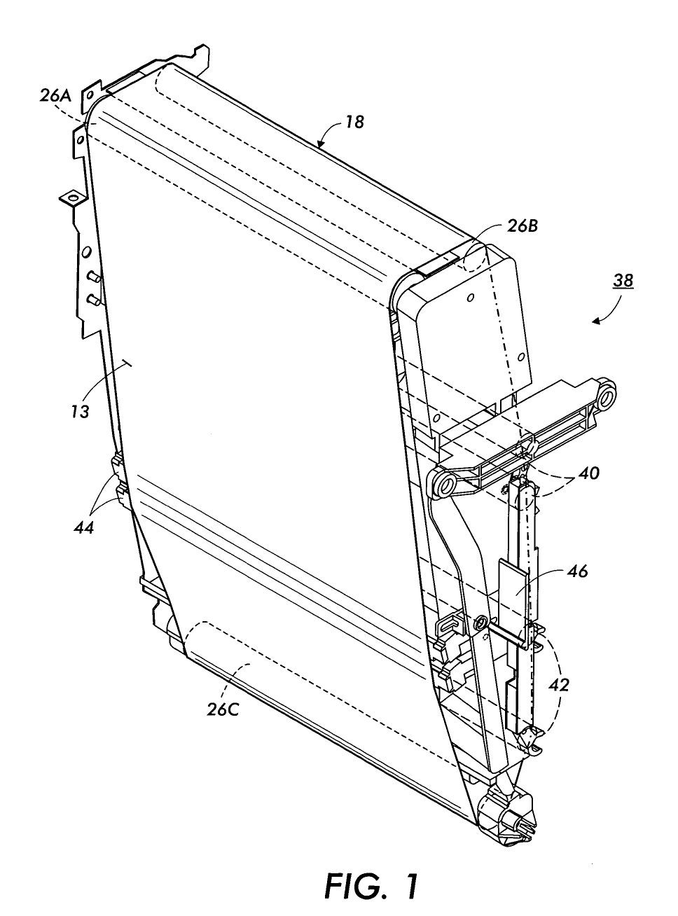

FIG. 1 is a schematic perspective view of an exemplary embodiment of a photoreceptor module in a first position.

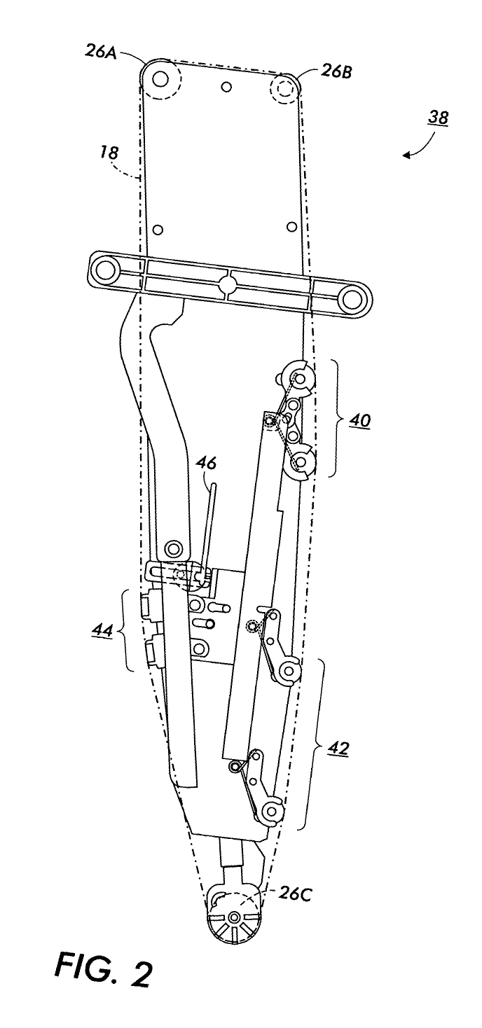

FIG. 2 is a schematic side view of an exemplary embodiment of a photoreceptor module in the first position

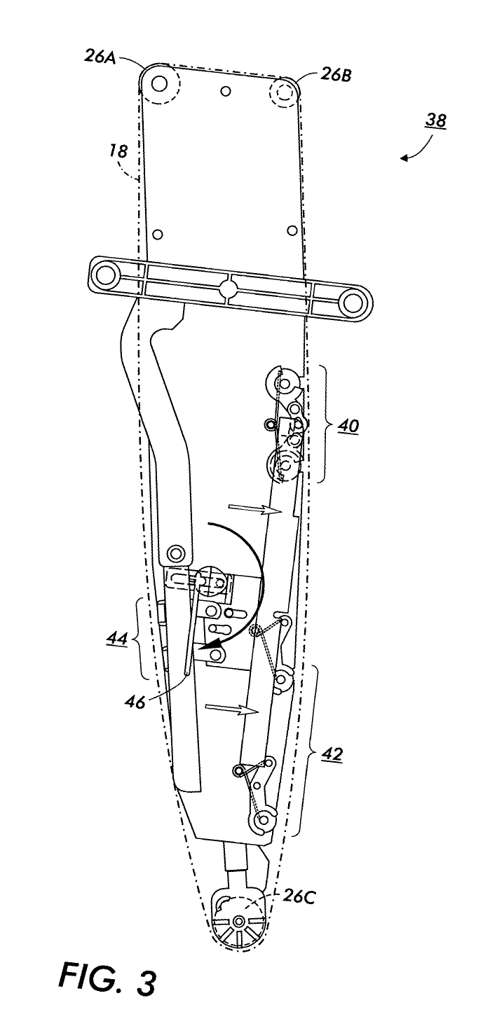

FIG. 3. is a schematic side view of an exemplary embodiment of a photoreceptor module in a second position

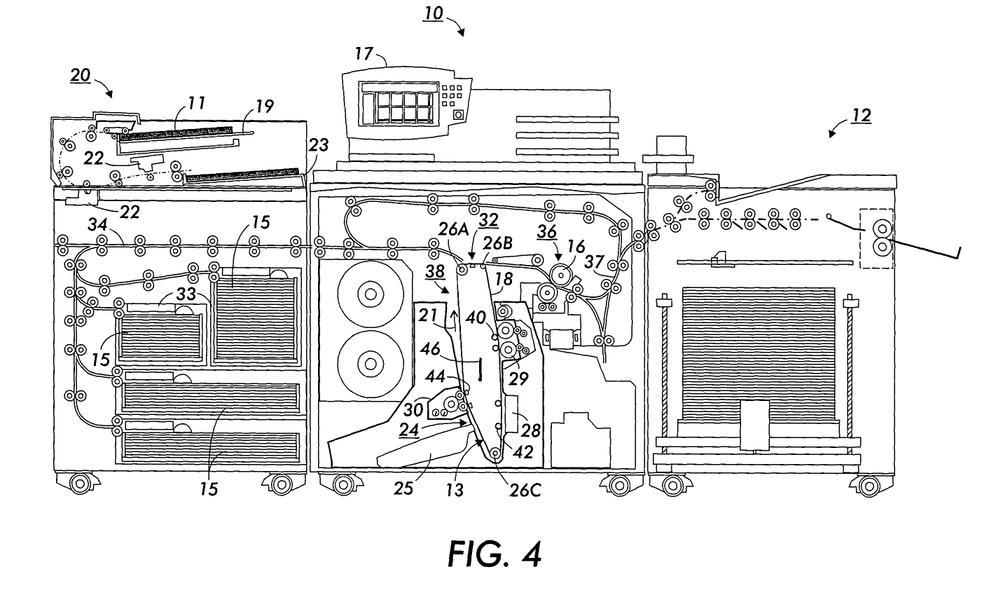

FIG. 4 is a schematic front elevation view of an exemplary embodiment of a photoreceptor module.

FIG. 4 shows a schematic front elevation view of an exemplary embodiment of a photoreceptor module 12 in the context of a printing device 10. The printing device 10 could be, for example, a xerographic copier or printer.

As in all xerographic machines, including the exemplary embodiment illustrated in FIG. 4, an image of an original document or set of documents 11 to be reproduced is projected or scanned onto a uniformly charged surface 13 of a photoreceptor 18 to form an electrostatic latent image thereon. Thereafter, the latent image is developed with an oppositely charged developing material called toner (not shown) to form a toner image, corresponding to the latent image on the photoreceptor surface. The toner image is then electrostatically transferred to a final support material or paper sheet 15, to which it may be permanently fixed by a fusing device 16.

In the illustrated device 10 of FIG. 7, a set of original documents 11 to be copied is placed on tray 19 of an automatic document handler 20. The machine operator enters the desired copying instructions, such as, for example, number of copies or sets of copies, through the control panel 17. The automatic document handler transports the documents 11 serially from the tray and past a scanning station 22 which scans each document, thereby producing digital image signals corresponding to the informational areas on the original document. Once scanned, the documents are deposited in an output tray 23. Additionally, information and instructions could come from a data storage medium or, if the device is connected to a network, they could come from a remote location such as a desktop computer.

The image signals are projected upon the uniformly charged surface of the photoreceptor at an imaging station 24 by a raster output system 25 to form a latent electrostatic image. of the scanned informational areas of the original document thereon as the photoreceptor is moved passed the imaging station. The photoreceptor 18 is in the form of a flexible, endless belt 18 having a photoconductive outer surface 13 and is mounted on a photoreceptor module 38. The belt 18 is supported by a set of rollers 26A, 26B, 26C and a plurality of backing members located opposite various stations. At least one of the rollers 26A is driven to move the photoreceptor belt 18 in the direction indicated by arrow 21 at a constant rate of speed about the rollers and past the various xerographic processing stations. Before entering the imaging station 24, a charging station 28 uniformly charges the photoreceptor surface 13. The exposure of the charged surface of the photoreceptor to the digital signals at the imaging station discharges the photoreceptor surface in the areas struck by the digital image signals. Thus, there remains on the photoreceptor surface a latent electrostatic image in image configuration corresponding to the informational areas on the original. As the photoreceptor continues its movement, the latent electrostatic image thereon passes through developing station 30 where oppositely charged toner is deposited on the latent electrostatic image to form a toner image.

The photoreceptor movement continues transporting the toner image from the developer station to a transfer station 32. A paper supply 33 feeds a sheet 15 to a sheet transport 34 for travel to the transfer station. The sheet moves into aligned and registered contact with the toner image at a speed synchronistic with the moving photoreceptor. Transfer of the toner image to the sheet is effected and the sheet with the toner image is stripped from the photoreceptor and conveyed to a fusing station 36 having fuser device 16 where the toner image is fused to permanently fix the toner image to the sheet. After the toner image is fixed to the sheet, the sheet is transported by sheet transporting mechanism 37 to a finishing station 12 where the sheets with the permanent images thereon may be compiled into sets of sheets and finished by being stapled, bound, or the like.

Suitable drive means (not shown) for the document creating apparatus are arranged to drive the photoreceptor in timed relationship to the scanning of the original document and forming the latent electrostatic image on the photoreceptor, to effect development of the latent electrostatic image, to separate and feed sheets of paper, to transport. same through the transfer station in time registration with the toner image, and to convey the sheet of paper with the toner image through the fusing station to fix the toner image thereto in a timed sequence to produce copies of the original documents.

The foregoing description is believed to be sufficient for the purposes of showing the general operation of document creating apparatus. FIGS. 1-3 illustrate an exemplary embodiment of the photoreceptor module 12 in greater detail.

FIG. 2 illustrates an exemplary embodiment of the photoreceptor module from a side perspective. In embodiments, multiple backing members are used to keep the photoreceptor belt 18 in a desired position. In FIG. 2 for example, a pair of backer rollers 40 are positioned opposite the cleaning station 29. A second pair of backer rollers 42 are located opposite the charging station 28. Finally, a pair of backer bars 44 are located opposite the developing station 30. The exact arrangement of the stations and the arrangement and number of backing members may, of course, vary from machine to machine.

The module 12 also includes a tension roller 26C to supply tension to the belt 18. The belt 18 needs to have sufficient tension to enable a flat belt in, for example, the developing and transfer zones. In embodiments, the tension roller 26C is a spring-loaded roller that keeps the photoreceptor belt 18 taut.

When a photoreceptor module such as the module 12 illustrated in FIGS. 1-3 is in an operating position with the printing device 10, the module occupies a particular “footprint” within the machine. The footprint of an object is the volume and shape of space it occupies. Due to various factors, the interior modules of modern printing devices are often closely spaced. This makes accessing a particular module without disturbing neighboring modules difficult. For example, the photoreceptor module typically has to be in close proximity to the developer module and the fusing module. This can make accessing and servicing the photoreceptor module a delicate operation.

To enable easier servicing of the photoreceptor module 12 from the device 10, the backing members can be retractable to remove some of the difficulty associated with servicing the photoreceptor module. When backing members are retracted, the spring-loaded tension roller 26C extends further downward and the belt 18 is pulled so that it occupies a narrower space. See FIG. 3. FIG. 3 is the same image as FIG. 2, except the backing members are retracted and the photoreceptor module 12 occupies a narrower footprint.

In embodiments, an actuating mechanism is used to retract the backing members. In FIGS. 1-4, the actuating mechanism is shown as a lever 46. The lever 46 would be connected to some or all of the backing members. In embodiments, actuating the lever 46 would allow simultaneous retraction of multiple backing members. When the backing members are retracted the tension roller 26C takes up the slack in the photoreceptor belt 18, this changing the footprint of the photoreceptor module 12. Moving this lever 46 allows the user to adjust the footprint of the photoreceptor module 12. It accomplishes this by retracting at least some of the backing members so that the photoreceptor module 12 changes from its operating mode to its servicing mode. In embodiments, the lever retracts all the backing members simultaneously.

In FIGS. 1 and 2, the lever 46 is shown in a first position when the photoreceptor module 12 is in its operating position within the device 10. FIG. 3 shows the lever in its actuated position, where the backing members are retracted. In embodiments, the user is blocked from removing the photoreceptor module unless the lever 46 was in its actuated position. This would help prevent accidental damage to the photoreceptor surface.

While the lever 46 has been referred to as having an operating position and an actuated position, it should of course be obvious that the operating position may be referred to as an actuated position and what is termed the actuated position may be referred to as the narrower footprint position of the photoreceptor module. The selection of the operating position as being the starting position was arbitrary. What is important is that the lever 46 can be used to change the footprint of the module between an operating position and a servicing position.

Other types of actuating mechanisms may include an electrical switch, toggle, sliding bar, or push button.

In practice, a user of a device incorporating the described photoreceptor module 12 who wanted to service the belt 18 or other part of the module would first power down the device 10. Then the user would actuate the lever 46 on the photoreceptor module 12. This would narrow the footprint of the module thereby allowing the module 12 to be removed from the device more easily. When the module was removed the belt 18, for example, could be serviced or replaced with a new belt. After the module 12 was serviced, it could be reinserted into the device 10, the lever arm 46 would then be shifted back into its operating position and normal printing could resume.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention.

1. A photoreceptor module, comprising:
a plurality of backing members;
a tension roller for creating tension in the belt;
a photoreceptor belt, which wraps around the backing members and the tension roller,
wherein the backing members are retractable such that the tension roller deforms the shape of the belt enough to ease the movement of the module between surrounding modules.

2. The module of claim 1, further comprising an actuating mechanism for retracting the backing members.

3. The module of claim 2, wherein the actuating mechanism is a lever.

4. The module of claim 3, wherein the lever can be actuated to retract a plurality of the backing members simultaneously.

5. The module of claim 4, wherein the lever can be actuated to retract all of the backing members simultaneously.

6. The module of claim 3, wherein the lever must be retracted before the module may moved out of an operating position.

7. The module of claim 1, wherein the tension roller is spring-loaded.

8. A method for detensioning a photoreceptor belt comprising simultaneously retracting multiple backing members located on a photoreceptor module.

9. The method of claim 8, wherein a tension roller deforms the shape of the belt when the backing members are retracted.

10. The method of claim 8, wherein a lever is used to simultaneously retract the multiple backing members.

11. The method of claim 10, wherein all the backing members on a photoreceptor module are retracted simultaneously.

12. A method for servicing a photoreceptor module having a photoreceptor belt, a tension roller, and multiple backing members, comprising:
retracting the multiple backing members such that the tension roller can deform the shape of the belt;
removing the photoreceptor module from inside a printing device;
servicing the module;
inserting the photoreceptor module into the printing device.

13. The method of claim 12, wherein retracting the backing members is accomplished by a single actuating mechanism.

14. The method of claim 13, wherein the mechanism is a lever.

15. The method of claim 12, wherein the backing members are retracted simultaneously.

16. The method of claim 15, wherein all the backing members of the photoreceptor module are retracted simultaneously.

17. A photoreceptor module, comprising:
a plurality of backing members;
a photoreceptor belt, which wraps around the backing members;
wherein the backing members are retractable such that the shape of the belt deforms enough to ease the movement of the module between surrounding modules.

18. The module of claim 17, further comprising a lever for retracting the backing members.

19. The module of claim 18, wherein the lever can be actuated to retract a plurality of the backing members simultaneously.

20. The module of claim 19, wherein the lever can be actuated to retract all of the backing members simultaneously.

21. The module of claim 19, wherein the lever must be retracted before the module may be moved out of an operating position.
